(19) United States
(12) Patent Application Publication
(10) Pub. No.: US 2015/0283820 A1
(43) Pub. Date: Oct. 8, 2015

(54) METHOD OF REMOVING AIR BUBBLES FROM CIRCULATING INK DELIVERY SYSTEM

(71) Applicant: MEMJET TECHNOLOGY LIMITED, Dublin 2 (IE)

(72) Inventors: Edward Esdaile-Watts, North Ryde (AU); Gilbert Alemana, North Ryde (AU); Robert Brice, North Ryde (AU); Kianoush Mir Sanaei, North Ryde (AU)

(21) Appl. No.: 14/741,728

(22) Filed: Jun. 17, 2015

Related U.S. Application Data
(63) Continuation of application No. 13/931,093, filed on Jun. 28, 2013.
(60) Provisional application No. 61/669,868, filed on Jul. 10, 2012.

(51) Int. Cl. B41J 2/19

(52) U.S. Cl. CPC B41J 2/19

(57) ABSTRACT

A method of removing air bubbles from a circulating ink delivery system supplying ink to an inkjet printhead. The ink delivery system includes an ink container positioned below the printhead, an upstream ink conduit interconnecting a supply port of the ink container and a first port of the printhead, and a downstream ink conduit interconnecting a return port of the ink container and a second port of the printhead. The method includes the step of: pumping ink around the ink delivery system from the supply port to the return port, wherein a flow speed of ink through the downstream ink conduit is greater than a flow speed of ink through the upstream first conduit.

### FIELD OF THE INVENTION

This invention relates to an ink delivery system for an inkjet printer. It has been developed primarily for flushing air bubbles from a printhead.

### BACKGROUND OF THE INVENTION

Inkjet printers employing Memjet® technology are commercially available for a number of different printing formats, including home-and-office (“SOHO”) printers, label printers and wideformat printers. Memjet® printers typically comprise one or more stationary inkjet printheads, which are user-replaceable. For example, a SOHO printer comprises a single user-replaceable multi-colored printhead, a high-speed label printer comprises a plurality of user-replaceable monochrome printheads aligned along a media feed direction, and a wideformat printer comprises a plurality of user-replaceable multi-colored printheads in a staggered overlapping arrangement so as to span across a wideformat pagewidth.

Providing users with the ability to replace printheads is key advantage of the Memjet® technology. However, this places demands on the ink delivery system supplying ink to the printhead(s). For example, the ink delivery system should allow expired printheads to be deprimed before replacement so as not to cause inadvertent ink spillages and allow new printheads to be primed with ink after installation.

In addition to these requirements, it would be desirable to minimize the “wake-up” time of inkjet printers. Air bubbles trapped in printheads are a perennial problem and a common cause of print artifacts, and it would be desirable to improve the efficiency of air bubble purging operations, which are typically performed during printer “wake-up”.

A number of approaches towards ink delivery systems for inkjet printheads have been described in US2011/0025762; US2011/0279566; and US2011/0279562 (all assigned to the present Applicant), the contents of which are incorporated herein by reference.

The ink delivery systems described previously in connection with Memjet® printers generally comprise a closed loop system having first and second ink conduits interconnecting an ink container with respective first and second ink ports of the printhead. A reversible pump is positioned in the second ink conduit for pumping ink around the closed loop. Typically, a pinch valve is positioned on the first ink conduit for controlling the flow of ink or air through the printhead. As described in US2011/0279566 and US2011/0279562, the pump and pinch valve are coordinated to provide a multitude of printhead priming, depriming and other maintenance or recovery operations.

It would be desirable to modify the ink delivery systems described in US2011/0279566 and US2011/0279562 so as to improve the efficiency of air bubble purging and minimize printer “wake-up” times.

### SUMMARY OF THE INVENTION

In accordance with the present invention, there is provided an inkjet printer comprising:

a printhead having a first port and a second port;

an ink container for supplying ink to the printhead, the ink container comprising a supply port and a return port;

a first ink conduit interconnecting the supply port and the first port;

a second ink conduit interconnecting the return port and the second port; and

a pump for pumping ink from the supply port to the return port,

wherein the second ink conduit has a smaller internal cross-sectional area than the first ink conduit.

The printer according to the present invention advantageously provides a high flow speed of ink in the second conduit relative to the first conduit when the pump is actuated by virtue of the relatively smaller internal cross-sectional area of the second ink conduit. (Note that the flow rate is the same in both conduits, but the flow speed is higher in the second conduit). This relatively higher flow speed in the second conduit facilitates removal of trapped bubbles in the second conduit by entrainment of the bubbles in the higher flow speed. Consequently, these trapped air bubbles are returned from the second conduit more efficiently to the ink container where they can be removed (e.g. by escaping to atmosphere). Air bubbles are particularly problematic in the second conduit when the ink container is positioned below a height of the printhead. This is because the natural buoyancy of the air bubbles tends to counter the flow direction in the second conduit. Hence, the higher flow speed in the second conduit encourages removal of air bubbles from the second ink conduit and advantageously provides optimized printhead priming or flushing.

As used herein, references to ‘ink’ will be taken to include any printable fluid for creating images and indicia on a media substrate, as well as any functionalized fluid such as fixatives, infrared inks, UV inks, surfactants, medicaments, 3D-printing fluids etc.

As used herein, the term “the second ink conduit has a smaller internal cross-sectional area than the first ink conduit” is taken to mean that the majority of the length of the second ink conduit has a smaller cross-sectional area than the majority of the length of the first ink conduit, such that the flow speed through the second ink conduit is generally faster than the flow speed through the first ink conduit.

Preferably, the first and second ink conduits are defined, at least partially, by respective first tubing and second tubing, wherein the second tubing has a smaller internal diameter than the first tubing. The tubing is typically flexible polymer tubing having a circular cross-section.

Preferably, the pump is a peristaltic pump positioned in the second conduit. Typically, the peristaltic pump is configured to pump ink through the second conduit when actuated and to shut off the second conduit when not actuated.

Preferably, the pump is positioned above a height of the printhead. Positioning the pump above the height of the printhead advantageously moves bubbles towards the pump in a direction generally corresponding to the natural buoyancy of air bubbles. Once the air bubbles have moved past the pump, they are unable to return to the printhead unless the pump is actuated in a reverse direction.

Preferably, the second ink conduit comprises a first section between the second port and the pump and a second section between the pump and the ink container. Typically, the first section is wholly at or above the height of the printhead.

Preferably, the printer further comprises:
an air conduit connected to the first ink conduit, the air conduit having an air inlet in fluid communication with atmosphere; and
a first valve configured for controlling a flow of air through the air conduit,

wherein the first valve is positioned below a height of the printhead.

Positioning the first valve below the height of the printhead advantageously maintains a negative ink pressure at printhead nozzles when the first valve is opened to atmosphere. Therefore, this arrangement minimizes ink drooling from the nozzles when the first valve is open (Ink is unable to drain into the air conduit from the printhead by virtue of the surface tension of menisci in the printhead nozzles).

By contrast, if the first valve were to be positioned above the height of the printhead, a positive ink pressure is experienced at the printhead nozzles when the first valve is opened, thereby increasing the risk of ink drooling from the nozzles. Ink drooling is highly undesirable during printhead replacement, because users have increased risk of ink staining skin, clothing etc.

Preferably, the first ink conduit comprises a third section between the ink container and the air conduit, and a fourth section between the air conduit and the first port.

Preferably, the fourth section is wholly at or below the height of the first port.

Preferably, the printer comprises a second valve for controlling a flow of ink through the third section.

Preferably, the second valve is a pinch valve.

Preferably, the first valve is a pinch valve.

Preferably, the first and second valves are contained in a multi-channel valve arrangement.

Preferably, the multi-channel valve arrangement is a multi-channel pinch valve configured for pinching at least one of: the air conduit and the third section.

Preferably, the printer comprises a controller for controlling operation of the pump, the first valve and the second valve.

Preferably, the printhead is user-replaceable.

Preferably, the ink container is positioned below a height of the printhead.

Preferably, the ink container is open to atmosphere, such that ink is supplied to the printhead under gravity and at negative hydrostatic pressure during normal printing.

The printer may comprise an ink reservoir (e.g. a replaceable ink cartridge or ink tank) in fluid communication with the ink container.

Preferably, the printer comprises a pressure-regulating system for controlling a height of ink in the ink container relative to the printhead.

Preferably, the pressure-regulating system comprises a regulator valve for controlling a flow of ink into the ink container from the ink reservoir. Alternatively, the pressure-regulating system may be a particular configuration (e.g. flattened profile) of the ink container for maintaining a substantially constant height of ink in the ink container relative to the printhead.

In another aspect, there is provided an inkjet printer comprising:

a printhead having a first port and a second port;

an ink container for supplying ink to the printhead, the ink container comprising a supply port and a return port;

a first ink conduit interconnecting the supply port and the first port;

a second ink conduit interconnecting the return port and the second port; and

a pump positioned in the second ink conduit,

wherein the pump is positioned above a height of the printhead.

Preferably, the second ink conduit has a smaller internal cross-sectional area than the first ink conduit.

### BRIEF DESCRIPTION OF THE DRAWINGS

Embodiments of the present invention will now be described by way of example only with reference to the accompanying drawings, in which:

FIG. 1 shows schematically an inkjet printer according to the present invention;

FIG. 2 shows cutaway perspective views of the first and second ink conduits; and

FIG. 3 shows schematically a portion of the second ink conduit containing air bubbles.

### DETAILED DESCRIPTION OF THE INVENTION

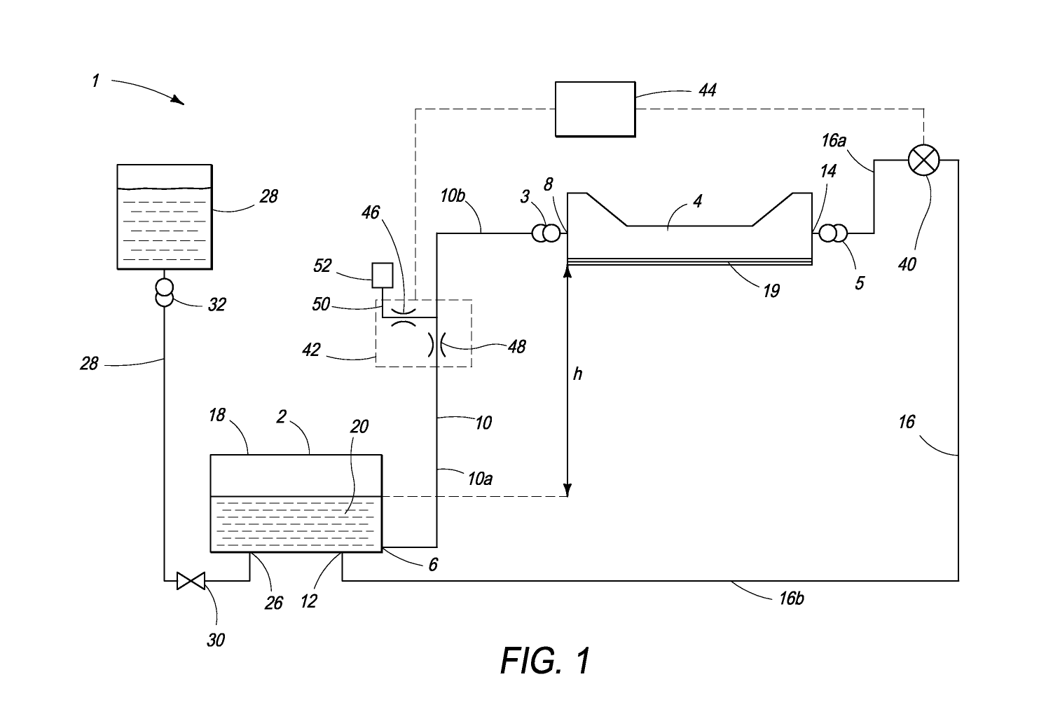

Referring to FIG. 1, there is shown schematically a printer 1 having an ink delivery system for supplying ink to a printhead. The ink delivery system is similar in function to those described in US2011/0279566 and US2011/0279562, the contents of which are herein incorporated by reference.

The printer 1 comprises an ink container 2 having a supply port 6 connected to a first port 8 of a printhead 4 via a first ink conduit 10. A return port 12 of the ink container 2 is connected to a second port 14 of the printhead 4 via a second ink conduit 16. Hence, the ink container 2, the first ink conduit 10, the printhead 4 and the second ink conduit 16 define a closed fluidic loop. Typically, the first ink conduit 10 and second ink conduit 16 are comprised of lengths of flexible tubing.

The printhead 4 is user-replaceable by means of a first coupling 3 releasably interconnecting the first port 8 and the first ink conduit 10; and a second coupling 5 releasably interconnecting the second port 14 and the second ink conduit 16. A more detailed description of the printhead 4 and its associated couplings can be found in, for example, US2011/0279566.

The ink container 2 is open to atmosphere via an air vent 18 in the form of an air-permeable membrane positioned in a roof of the ink container. Accordingly, during normal printing, ink is supplied to the printhead 4 at a negative hydrostatic pressure (“backpressure”) under gravity. The amount of backpressure experienced at the nozzle plate 19 of the printhead 4 is determined by the height h of the nozzle plate above the level of ink 20 in the ink container 2.

The printer 1 typically comprises a pressure-regulating system for maintaining a substantially constant level of ink in the ink container 2 and, therefore, a constant height h and corresponding backpressure. As shown in FIG. 1, the pressure-regulating system comprises a bulk ink reservoir 24 connected to an inlet port 26 of the ink container 2 via a supply conduit 28 having a pressure-regulating valve 30. In some embodiments, the inlet port 26 and the return port 12 may be the same port of the ink container 2, with the second ink conduit 16 and the supply conduit 28 joined together.

The pressure-regulating valve 30 controls a flow of ink from the ink reservoir 24 into the ink container 2 so as to maintain a substantially constant level of ink in the ink container. As described in US2011/0279566, the valve 30 may be mechanically controlled by means of a float mechanism inside the ink container 2. However, it will be appreciated that other forms of valve control may be employed, such as an ink level sensor monitoring a level of ink in the ink container 2 in combination with a controller for electronically controlling operation of the valve 30 based on feedback from the ink level sensor.

The ink reservoir 24 is typically a user-replaceable ink cartridge connected to the supply conduit 28 via a supply coupling 32. Alternatively, and as described in US2011/0279562, the ink container 2 may be a user-replaceable cartridge with the ink reservoir 24, supply conduit and 28 and regulator valve 30 absent. When the ink container 2 is a user-replaceable cartridge, the height h may be maintained substantially constant by virtue of a slim or flattened height profile of the ink cartridge. A flattened height profile of the ink container 2 ensures minimal variations in the height h between full and near-empty ink cartridges.

The closed fluidic loop, incorporating the ink container 2, the first ink conduit 10, the printhead 4 and the second ink conduit 16, facilitates priming, de-priming and other printhead maintenance operations. The second ink conduit 16 includes a reversible peristaltic pump 40 for circulating ink around the fluidic loop. Thus, the second ink conduit 16 has a first section 16a defined between the second port 14 and the pump 40, and a second section 16b defined between the return port 12 and the pump 40. By way of convention only, the “forward” direction of the pump 40 corresponds to pumping ink from the supply port 6 to the return port 12 (i.e. clockwise as shown in FIG. 1), and the “reverse” direction of the pump corresponds to pumping ink from the return port 12 to the supply port 6 (i.e. anticlockwise as shown in FIG. 1).

The pump 40 cooperates with a pinch valve arrangement 42 to coordinate various fluidic operations. The pinch valve arrangement 42 comprises a first pinch valve 46 and a second pinch valve 48, and may take the form of any of the pinch valve arrangements described in, for example, US 2011/0279566; US 2011/0279562; and U.S. Ser. No. 61/752,873, the contents of which are incorporated herein by reference.

The first pinch valve 46 controls a flow of air through an air conduit 50, which is branched from the first ink conduit 10. The air conduit 50 terminates at an air filter 52, which is open to atmosphere and functions as an air intake for the closed fluidic loop. The first pinch valve 46 is positioned below a height of the nozzle plate in order to minimize ink drooling from printhead nozzles when the first pinch valve 46 is open.

By virtue of the air conduit 50, the first ink conduit 10 is divided into a third section 10a between the supply port 6 and the air conduit 50, and a fourth section 10b between the first port 8 and the air conduit 50. The second pinch valve 48 controls a flow of ink through the third section 10a of the first ink conduit 10.

The pump 40, the first pinch valve 46 and the second pinch valve 48 are controlled by a controller 44, which coordinates various fluidic operations. From the foregoing, it will be appreciated that the ink delivery system shown in FIG. 1 provides a versatile range of fluidic operations. Table 1 describes various pinch valve and pump states for some example fluidic operations used in the printer 1. Of course, various combinations of these example fluidic operations may be employed.

TABLE 1
Example Fluidic Operations

| Fluidic | Second Pinch | First Pinch | |
|---|---|---|---|
| Operation | Valve 48 | Valve 46 | Pump 40 |
| PRINT | open | closed | off |
| PRIME | open | closed | forward |
| STANDBY | open | closed | off |
| PULSE | closed | closed | reverse |
| DEPRIME | closed | open | forward |
| NULL | closed | closed | off |

During normal printing (“PRINT” mode), the printhead 4 draws ink from the ink container 2 at a negative backpressure under gravity. In this mode, the peristaltic pump 40 functions as a shut-off valve, whilst the first pinch valve 46 is closed and the second pinch valve 48 is open to allow ink flow from the supply port 6 to the first port 8 of the printhead 4.

During printhead priming or flushing (“PRIME” mode), ink is circulated around the closed fluidic loop in the forward direction (i.e. clockwise as shown in FIG. 1). In this mode, the peristaltic pump 40 is actuated in the forward pumping direction whilst the first pinch valve 46 is closed and the second pinch valve 48 is open to allow ink flow from the supply port to the return port 12 via the printhead 4. Priming in this manner may be used to prime a deprimed printhead with ink or to flush air bubbles from the system. Flushed air bubbles are returned to the ink container 2 where they can be vented to atmosphere via the air vent 18.

In the “STANDBY” mode, the pump 40 is switched off whilst the first pinch valve 46 is closed and the second pinch valve 48 is open. The “STANDBY” mode maintains a negative hydrostatic ink pressure at the printhead 4, which minimizes color mixing on the nozzle plate 19 when the printer is idle. Usually, the printhead is capped in this mode to minimize evaporation of ink from the nozzles (see, for example, US2011/0279519, the contents of which are herein incorporated by reference).

In order to ensure each nozzle of printhead 4 is fully primed with ink and/or to unblock any nozzles which have become clogged, a “PULSE” mode may be employed. In the “PULSE” mode, the first and second pinch valves 46 and 48 are closed, while the pump 40 is actuated in a reverse direction (i.e. anticlockwise as shown in FIG. 1) to force ink through nozzles defined in the nozzle plate 19 of the printhead 4.

In order to replace a spent printhead 4, it is necessary to de-prime the printhead before it can be removed from the printer. In the “DEPRIME” mode, the first pinch valve 46 is open, the second pinch valve 48 is closed and the pump 40 is actuated in the forward direction to draw in air from atmosphere via the air conduit 50. Once the printhead 4 has been deprimed of ink, the printer is set to “NULL” mode, which isolates the printhead from the ink supply, thereby allowing safe removal of the printhead with minimal ink spillages.

When the printer 1 is switched on or when the printer wakes up from an idle period (e.g. by being sent a new print job), the ink delivery system must ensure the printhead 4 is in a state ready for printing. Typically, this will involve a prime and/or a pulse operation, usually in combination with various other maintenance operations (e.g. wiping, spitting etc) depending, for example, on the period of time since the last print job.

In the field of high-speed inkjet printing and, indeed, any type of printing, the user generally has an expectation that printing will be initiated within a few seconds of sending a print job to a printer. Delays experienced while the printer wakes up can be frustrating for users, especially if the print job is relatively short. Nevertheless, these “wake-up” operations are essential for ensuring adequate print quality from the first print.

A significant amount of time spent during printer “wake-up” is dedicated to flushing air bubbles from the printhead 4 and ink delivery system. Air bubbles are a perennial problem in inkjet printers and can cause significant loss of print quality if the air bubbles block fluid lines and/or nozzles. Typically, air bubbles are caused by outgassing of ink; if a printer is left idle for a period time, and especially if the printer experiences temperature fluctuations (e.g. day/night temperature fluctuations) during that period, then a significant number of outgassed air bubbles may be present in the ink delivery system. These air bubbles should be removed, as far as possible, before printing commences and this may be achieved by circulating ink through the ink delivery system for a sufficient period of time.

Air bubbles have a natural buoyancy in ink and tend to rise upwards towards the highest point of the ink delivery system. This buoyancy makes it relatively difficult to move air bubbles through the second ink conduit 16 towards the return port 12 of the ink container 2, because the air bubbles naturally move in the opposite direction to the flow of ink. It will further be appreciated that air bubbles in the second ink conduit 16 are problematic when performing a “PULSE” operation, because it is undesirable to reintroduce air bubbles into the printhead 4 from the second ink conduit.

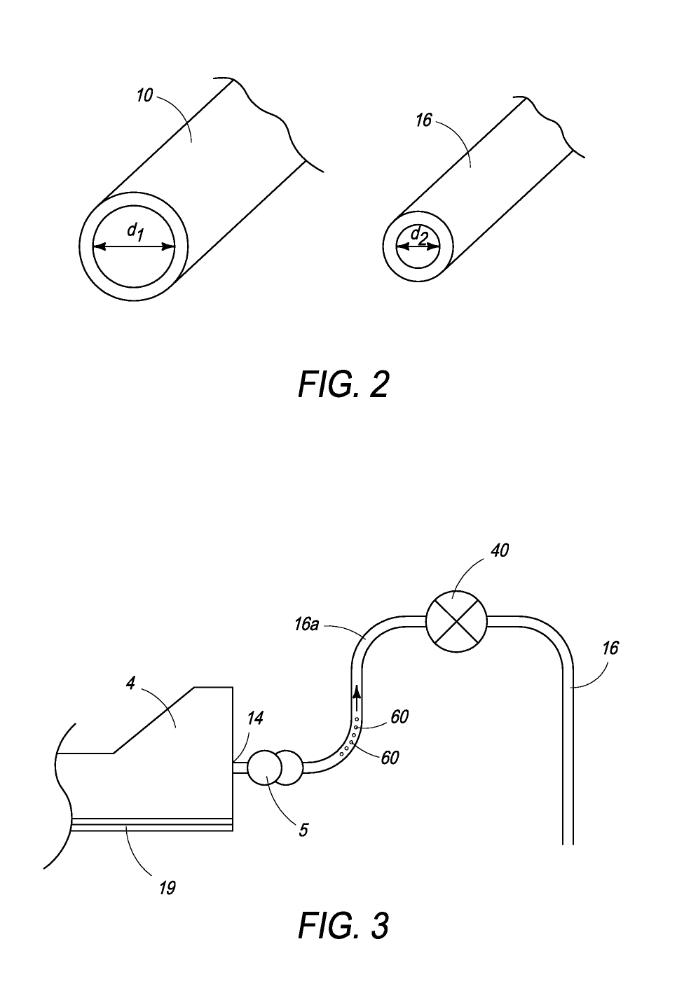

In order to encourage movement of air bubbles in the second ink conduit 16 towards the return port 12 during priming or flushing, the second ink conduit has a relatively smaller internal diameter than the first ink conduit 10. FIG. 2 shows cutaway perspectives of the first ink conduit 10 and second ink conduit 16 having respective internal diameters d₁ and d₂. The internal diameter d₂ of the second ink conduit 16 is relatively smaller than the internal diameter of the first ink conduit d₁.

Typically, the second ink conduit 16 has a cross-sectional area which is at least 2 times less or at least 3 times less than the cross-sectional area of the first ink conduit 10. For a given flow rate, this translates into a flow speed in the second ink conduit 16 which is at least 2 times greater or at least 3 times greater than the flow speed in the first ink conduit 10. Typically, the ratio of d₁:d₂ is in the range of 4:1 to 1.5:1. For example, the second ink conduit 16 may have an internal diameter d₂ in the range of about 1 to 2 mm, and the first ink conduit 10 may have an internal diameter d₁ in the range of about 2 to 4 mm. In one preferred embodiment, the internal diameter d₁ of the first ink conduit 10 is twice that of the internal diameter d₂ of the second ink conduit 16.

As foreshadowed above, the relatively smaller internal diameter d₂ of the second ink conduit 16 increases the flow speed of ink through the second ink conduit 16, which encourages entrainment of the air bubbles into the relatively fast flowing ink. This assists in removing air bubbles from the second ink conduit 16 more rapidly than would otherwise be the case. An additional advantage is a reduction in the volume of ‘stranded’ ink in the second ink conduit 16.

On the other hand, any air bubbles in the first ink conduit 10 naturally follow the flow of ink during a printhead priming operation and do not require additional encouragement to become entrained in the ink flow. Accordingly, the internal diameter d₁ of the first ink conduit 10 can be optimized for printing requirements. Usually, a relatively larger diameter for the first ink conduit 10 is desirable in terms of smoother ink delivery to the printhead 4 and reducing the risk of blockages.

In addition to the measure of reducing the internal diameter of the second ink conduit 16 relative to the first ink conduit 10, the removal of air bubbles is further enhanced by positioning the peristaltic pump 40 above the height of the nozzle plate 19. Accordingly, and referring now to FIG. 3, air bubbles 60 tend to rise upwards through the first section 16a of the second ink conduit towards the peristaltic pump 40. Once the air bubbles have moved past the peristaltic pump 40 into the second section 16b of the second ink conduit, they cannot return past the pump in the opposite direction and back into the printhead 4, unless the pump is actuated in the reverse direction. In order that air bubbles cannot return to the printhead 4 when the pump is actuated in the reverse direction (e.g. during a “PULSE” operation), the volume of the first section 16a of the second ink conduit is preferably larger than the volume of ink forced through the printhead during the “PULSE” operation. Self-evidently, it would undesirable if any air bubbles in the second section 16b were able to re-enter the printhead 4 during the “PULSE” operation and ensuring a sufficient volume of the first section 16a minimizes the risk of this occurring.

As described above, these measures described above optimize the efficiency of air bubble purging in the printer 1 and, therefore, enable reduced “wake-up” times by reducing the amount of time required to flush air bubbles from the ink delivery system.

For the sake of clarity, the present invention has been described in connection with a single ink channel. However, it will of course be appreciated that the present invention may be employed with multiple ink channels (e.g. CMYK, CMYKK, CMY etc). For example, the printhead 4 may comprises N ink channels supplied with ink from N ink containers 2, with each of the N ink containers 2 connected to the printhead via respective first and second ink conduits 10 and 16. (Typically, N is an integer from 2 to 10). In the case of multiple ink channels, the printer 1 typically employs shared components in the ink delivery system, such as a multiple channel peristaltic pump 40, a multiple channel pinch valve arrangement 42 and multiple channel printhead couplings 3 and 5.

It will, of course, be appreciated that the present invention has been described by way of example only and that modifications of detail may be made within the scope of the invention, which is defined in the accompanying claims.

1. A method of removing air bubbles from a circulating ink delivery system supplying ink to an inkjet printhead, the ink delivery system comprising an ink container positioned below the printhead, an upstream ink conduit interconnecting a supply port of the ink container and a first port of the printhead, and a downstream ink conduit interconnecting a return port of the ink container and a second port of the printhead, the method comprising the step of:
pumping ink around the ink delivery system from the supply port to the return port, wherein a flow speed of ink through the downstream ink conduit is greater than a flow speed of ink through the upstream first conduit.

2. The method of claim 1, wherein a majority of a length of the downstream ink conduit has a smaller internal cross-sectional area than a majority of a length of the upstream ink conduit.

3. The method of claim 1, wherein a pump is positioned in the downstream ink conduit for pumping ink around the ink delivery system.

4. The method of claim 3, wherein the pump is a peristaltic pump, the peristaltic pump shutting off the downstream second conduit when not pumping ink.

5. The method of claim 3, wherein the pump is proximal the printhead relative to the ink container.

6. The method of claim 1, wherein air bubbles in the ink are vented to atmosphere via a vent in the ink container.

7. The method of claim 1, wherein an ink valve is positioned in the upstream ink conduit and the method further comprises the steps of:
closing the ink valve; and
pumping ink around the ink delivery system from the return port towards the supply port so as to prime nozzles in the printhead with ink.
